(19) United States
(12) Patent Application Publication
(10) Pub. No.: US 2025/0154824 A1
(43) Pub. Date: May 15, 2025

(54) Louvre Window

(71) Applicant: Alchin Long Group IP Pty Limited, Wetherill Park (AU)

(72) Inventor: David Winston, Wetherill Park (AU)

(21) Appl. No.: 18/592,236

(22) Filed: Feb. 29, 2024

(30) Foreign Application Priority Data
Nov. 9, 2023 (AU) 2023903604

(51) Int. Cl. E06B 7/084

(52) U.S. Cl. CPC E06B 7/084

(57) ABSTRACT

A louvre window may have a frame, a handle mounted to the frame, and a plurality of blade assemblies located within the frame. Each blade assembly may include a center blade connected to the handle, a first blade connected to the center blade, a first windowpane attached to the first blade, a second blade connected to the center blade, and a second windowpane attached to second blade. Operation of the handle may cause movement of the center blade between an open position and a closed position, wherein in the closed position the first windowpane is separated from the second windowpane by a first distance, and in the open position the first windowpane is separated from the second windowpane by a second distance.

### RELATED APPLICATIONS

The present application claims priority from Australian Provisional Patent Application No. 2023903604, the contents of which are incorporated herein in their entirety by reference thereto.

### FIELD

The present disclosure relates to a louvre window. In particular, the disclosure relates to a blade assembly for a louvre window.

### BACKGROUND

Due to increasing emission standards, there is pressure on louvre window assemblies to be designed in more energy efficient ways. One important aspect is to provide more than a single barrier between the inside and outside of the louvre window. Previous designs have attempted to do so by making each pane of a known louvre window from a double-glazed unit. However, thermal losses through a louvre window are also strongly correlated with the quality of the panel-to-panel seals in the closed position of the window, meaning that the use of the double-glazed panel unit is not as effective as would be desirable.

A prior publication by the Applicant, US 2023/0062025 A, the contents of which are incorporated herein in their entirety by reference, contemplates the use of a blade assembly having two independent panes of glass, creating two separate lines of seals in the closed position, which may be more effective than the use of double-glazed units as singular panes. A sliding mechanism is proposed that allows movement of the independent panes of glass relative to each other so that the blade assemblies can pivot to the open position.

However, issues with the construction remain. For example, the two separate lines of seals create additional visual impediment when the window is in the closed position.

### SUMMARY

It is an object of some embodiments of the present disclosure to substantially overcome, or at least ameliorate, one or more of the disadvantages of the above mentioned louvre windows, or at least provide a useful alternative to the discussed louvre windows.

There is disclosed herein a louvre window having:
a frame, the frame having a head, a sill and at least two jambs;
a handle mounted to the frame;
a plurality of blade assemblies located within the frame, each blade assembly having:
   a center blade connected to the handle, such that the center blade pivots about a blade assembly axis when the handle is actuated;
   a first blade connected to the center blade;
   a first windowpane attached to the first blade;
   a second blade connected to the center blade; and
   a second windowpane attached to second blade,
wherein operation of the handle causes movement of the center blade between an open position and a closed position, wherein in the closed position the first windowpane is separated from the second windowpane by a first distance, and in the open position the first windowpane is separated from the second windowpane by a second distance,
wherein the first distance is less than the second distance.

In some embodiments, the first and second blades are connected to the center blade by a blade linkage.

In some embodiments, the blade linkage is pivotally mounted to the first blade, the second blade, and the center blade so as to be pivotable about first, second, and center linkage axes, respectively.

In some embodiments, the first, second, and center linkage axes are parallel to the blade assembly axis.

In some embodiments, the blade linkage includes at least two rigid blade linkage members, such that the first blade and the second blade remain parallel when the blade assembly moves between the open and closed positions.

In some embodiments, the first and/or second blade include cut-outs within which the blade linkage is mounted to each blade.

In some embodiments, the frame includes a blade guide groove, and the first blade includes a cam that is locatable in the blade guide groove,
wherein the blade guide groove is shaped such that when the blade assembly is moved between the closed position and the open position, the cam urges the first blade to move relative to the center blade.

In some embodiments, the groove includes a first portion adjacent a closed position end that extends substantially radially to the blade assembly axis, such that the change in separation between the first windowpane and the second windowpane between the first distance and the second distance occurs before substantial rotation of the blade assembly, and a second portion that extends substantially azimuthally to the blade assembly axis, such that the second distance is maintained during substantial rotation of the blade assembly.

In some embodiments, the first and/or second blade include a recess for accommodating at least a portion of the center blade, such that a width of the blade assembly in the closed position is less than the sum of a center blade width, a first blade width, and a second blade width.

In some embodiments, when the blade assembly is in the closed position, the first windowpane and the second windowpane are substantially vertically aligned.

In some embodiments, the plurality of blade assemblies includes a lower blade assembly and an upper blade assembly, and, when the blade assemblies are in the closed position, an upper end of the first windowpane of the first blade assembly and a top-most portion of the second windowpane of the first blade assembly meet a bottom-most portion of the first windowpane of the second blade assembly and a bottom-most portion of the second windowpane of the second blade assembly, respectively, each meeting creating a seal line,
wherein the seal lines of the first and second windowpanes are substantially vertically aligned.

### BRIEF DESCRIPTION OF THE DRAWINGS

For a more complete understanding of the present disclosure, exemplary embodiments of the disclosure are explained in more detail in the following description with reference to the accompanying drawing figures, in which like reference signs designate like parts and in which:

FIG. 1 is an isometric view of a louvre window according to an embodiment of the disclosure.

FIG. 2 is an exploded view of a portion of the louvre window of FIG. 1.

FIG. 3 is an isometric view of the louvre window of FIG. 1 in a closed position.

FIG. 4 is a side view of the louvre window of FIG. 3.

FIG. 5 is a stripped isometric view of the louvre window of FIG. 3.

FIG. 6 is a stripped side view of the louvre window of FIG. 3.

FIG. 7 is an isometric view of the louvre window of FIG. 1 between the closed position and an open position.

FIG. 8 is a side view of the louvre window of FIG. 7.

FIG. 9 is a stripped isometric view of the louvre window of FIG. 7.

FIG. 10 is a stripped side view of the louvre window of FIG. 7.

FIG. 11 is an isometric view of the louvre window of FIG. 1 in the open position.

FIG. 12 is a side view of the louvre window of FIG. 11.

FIG. 13 is a stripped isometric view of the louvre window of FIG. 11.

FIG. 14 is a stripped side view of the louvre window of FIG. 11.

### DETAILED DESCRIPTION

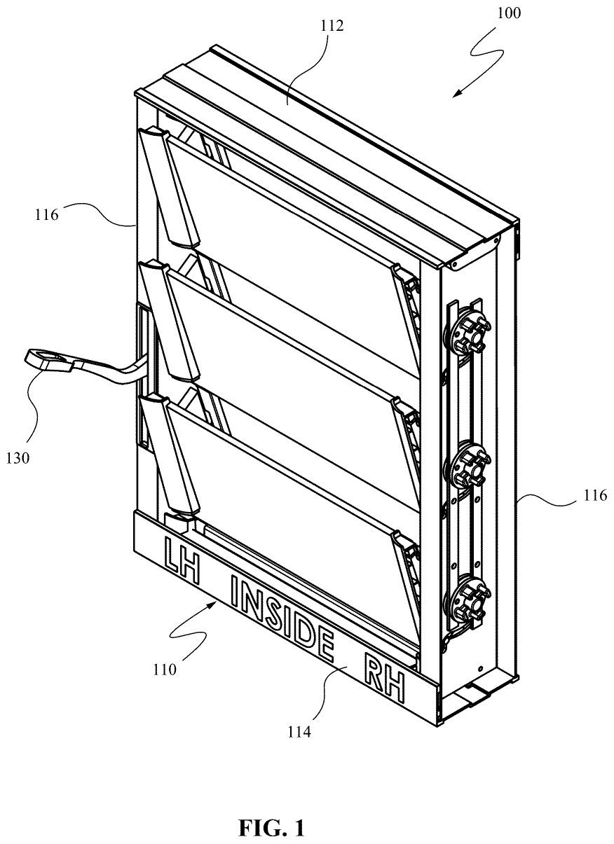

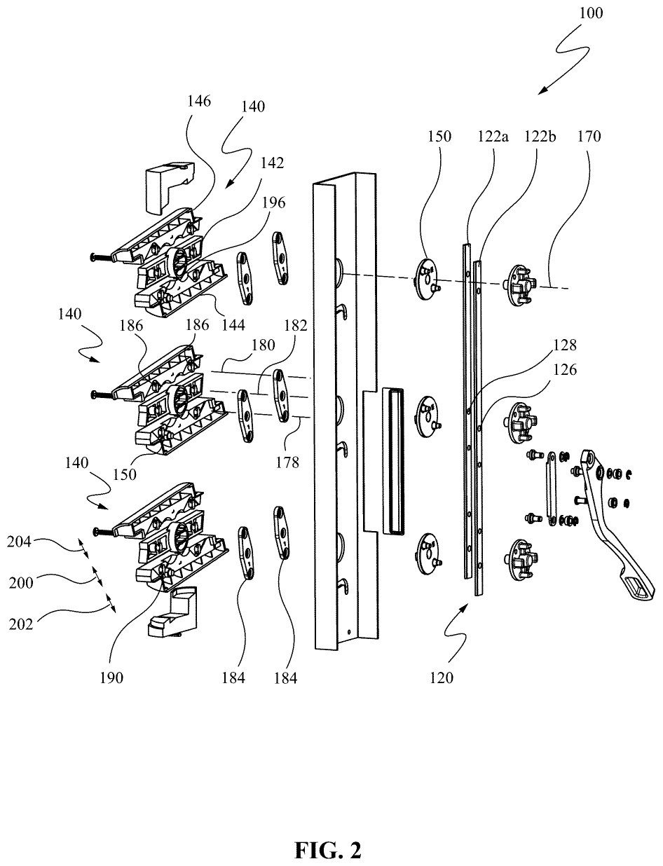

As shown in FIGS. 1 and 2, a louvre window 100 according to an embodiment of the disclosure includes a frame 110 having a head 112, a sill 114, and at least two jambs 116. The window 100 also includes a handle 130 mounted to the frame 110, in some embodiments on one of the jambs 116. Located within the frame 112 are a plurality of blade assemblies 140, each assembly 140 having a center blade 142, a first blade 144, and a second blade 146. The center blade 142 is connected to the handle 130, such that the center blade 142 pivots about a blade assembly axis 170 when the handle 130 is actuated. The handle 130 in some embodiments moves about a handle axis that is perpendicular to the blade assembly axis 170. The first blade 144 and the second blade 146 are connected to the center blade 142. As shown in FIG. 5, each blade assembly 140 further includes a first windowpane 160 attached to the first blade 142 and a second windowpane 162 attached to the second blade 144. The frame 110 includes corner projections spanning a portion of each jamb 116, sill 114, and head 112 to close the frame 112 when the blade assemblies 140 are in the closed position.

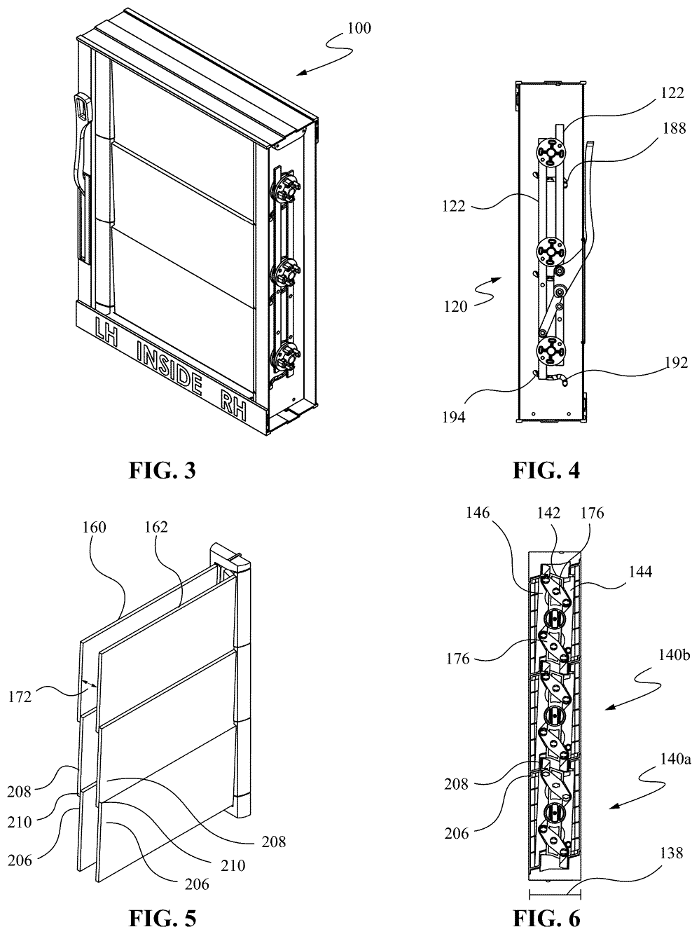

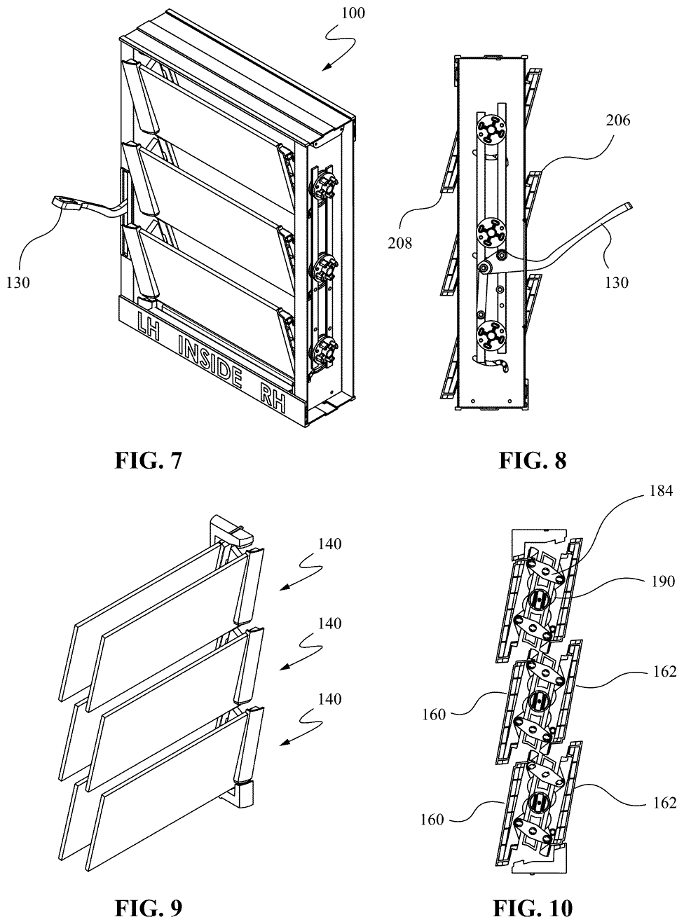

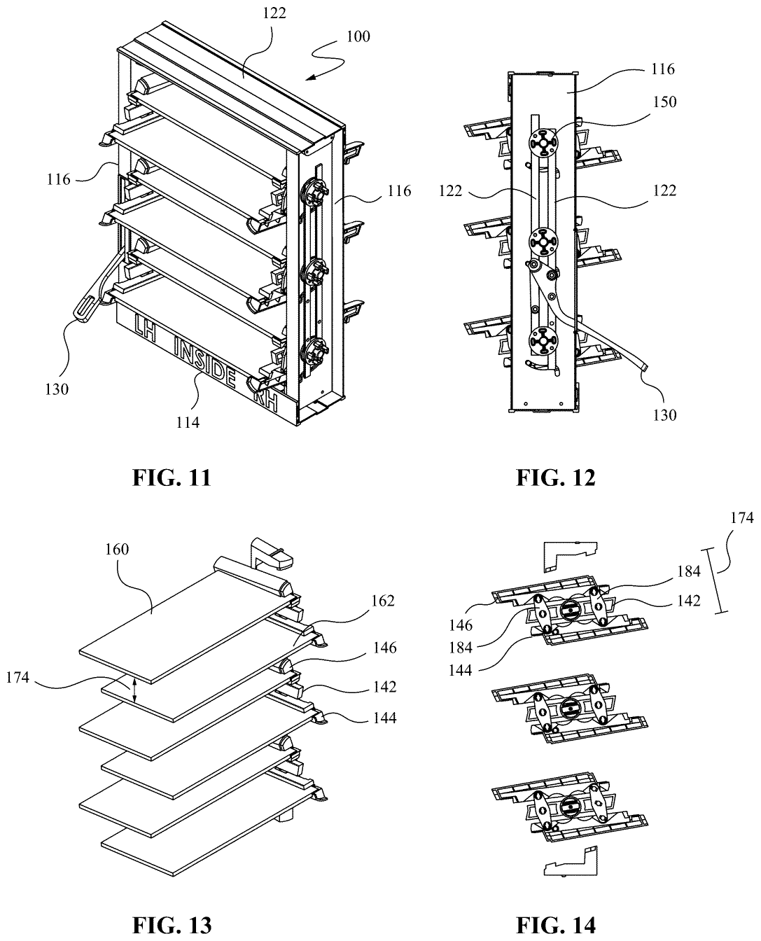

Operation of the handle 130 causes movement of the center blade 142 between a closed position, shown in FIGS. 3 to 6, and an open position, shown in FIGS. 11 to 14. The louvre window 100 includes a drive bar 120 located in at least one jamb 116, the drive bar 120 being movable by the handle 130. Each blade assembly 140 is connected to the drive bar 120 by a pivot drive connector 150. In some embodiments, the drive bar 120 includes a pair of link bars 122, with the pivot drive connector 150 being attached to each link bar 122 at opposing sides of the pivot drive connector 150. Thus, when the link bars 122 are moved in opposite directions, the pivot drive connector 150 is urged to pivot, as shown in FIGS. 4 and 5.

Returning to FIG. 2, each link bar 122 includes a recess 126 for each pivot drive connector 150 driven by the drive bar 120. In the closed position shown in FIG. 4, the recess 126 of a first link bar 122a is located adjacent the recess 126 of a second link bar 122b. When moved to the closed position shown in FIG. 5, the situation is reversed with the recess 126 of the first link bar 122a being adjacent the recess 126 of the second link bar. The pivot drive connector 150, in some embodiments, includes a first and second component, connected through the recess 126 with a snap fit.

In the closed position, the first windowpane 160 is separated from the second windowpane 162 by a first distance 172. In the open position, the first windowpane 160 is separated from the second windowpane 162 by a second distance 174. As can be seen from FIGS. 6, 10, and 14, the first distance 172 is less than the second distance 174. The increased distance 174 improves the ability to clean the windowpanes 160, 162 in the open position.

The first and second blades 144, 146 are, in some embodiments, connected to the center blade 142 by a blade linkage 176. The blade linkage 176 may be pivotally mounted to the first blade 144 about a first linkage axis 178, to the second blade 146 about a second linkage axis 180, and to the center blade 142 about a center linkage axis 182. In some embodiments, the linkage axes 178, 180, 182 are parallel to the blade assembly axis 170. The blade linkage 176 may include at least two rigid blade linkage members 184, each, in some embodiments, being pivotally connected to each of the center, first, and second blades 142, 144, 146. In this way the first and second blade 144, 146 remain parallel when the blade assembly 140 moves between the open and closed positions. Since the linkage members 184 are rigid, the first and second blades 144, 146 are also kept in equidistant relationship to the center blade 142 through the linkage members 184. In some embodiments the movement of the first and second blades 144, 146 is to maintain a parallelogram form.

As can be seen in FIGS. 6, 10, and 14, the first and/or second blade 144, 146 may include a cut-out 186 within which the blade linkage 176 is mounted to the respective blade 144, 146.

As best seen in FIGS. 4, 8, and 12, the frame 110 may include a blade guide groove 188, and the first blade 144 includes a cam 190 that is locatable in the blade guide groove 188. In some embodiments, each blade assembly 140 is associated with a respective blade guide groove 188. The cam 190 is, in some embodiments, located at a lower end of the first blade 144. The blade guide groove 188 may be shaped such that, when the blade assembly 140 is moved between the closed position and the open position, the cam 190 urges the first blade 144 to move relative to the center blade 142. Specifically, the first blade 144 may be urged to move away from the center blade 142 to contribute to the difference between the first distance 172 and the second distance 174. Since the second blade 146 is connected to the first blade 144 by the blade linkage 176 such that the second blade 146 remains parallel to the first blade 142, the second blade 146 is similarly urged to move relative to the center blade 142, in some embodiments, away from the center blade 142.

The blade guide groove 188 may include a first portion 192 adjacent a closed position end 212 and a second portion 194 adjacent an open position end 214. The first portion 192, in some embodiments, extends substantially radially to the blade assembly axis 170, such that the change in separation between the first windowpane 160 and the second windowpane 162 between the first distance 172 and the second distance 174 occurs before substantial rotation of the blade assembly 140. The second portion 194, in some embodiments, extends substantially azimuthally to the blade assembly axis 170, such that the second distance 174 is maintained during substantial rotation of the blade assembly 140.

As shown in FIG. 2, the first and/or second blade 144, 146 may include a recess 196 for accommodating at least a portion of the center blade 142. In this way, a width 198 of the blade assembly 140 may be less than the sum of a center blade width 200, a first blade width 202, and a second blade width 204.

As can be seen in FIGS. 5 and 6, when the blade assembly 140 is in the closed position, the first windowpane 160 and the second windowpane 162 are substantially vertically aligned. The plurality of blade assemblies 140 may include a lower blade assembly 140a and an upper blade assembly 140b. When the blade assemblies 140 are in the closed position, a top-most portion 206 of the first windowpane 160 of the lower assembly 140a meets a bottom-most portion 208 of the first windowpane 160 of the upper assembly 140b, creating a seal line 210. Similarly, a top-most portion 206 of the second windowpane 162 of the lower assembly 140a meets a bottom-most portion 208 of the second windowpane 162 of the upper assembly 140b, creating a further seal line 210. The seal lines 210 of the first and second windowpanes 160, 162 are, in some embodiments, substantially vertically aligned, to reduce the visual impairment of the separate windowpanes 160, 162 on the window 100 in the closed position.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, etc. are used merely as labels, and are not intended to impose numerical requirements on or to establish a certain ranking of importance of their objects.

### REFERENCE NUMERALS

100 louvre window
110 frame
112 head
114 sill
116 jambs
120 drive bar
122 link bar
126 recess
130 handle
140 blade assembly
142 center blade
144 first blade
146 second blade
150 pivot drive connector
160 first windowpane
162 second windowpane
170 blade assembly axis
172 first distance
174 second distance
176 blade linkage
178 first linkage axis
180 second linkage axis
182 center linkage axis
184 blade linkage member
186 cut-out
188 blade guide groove
190 cam
192 first portion of groove
194 second portion of groove
196 recess
198 width of blade assembly
200 center blade width
202 first blade width
204 second blade width
206 top-most portion
208 bottom-most portion
210 seal line
212 closed position end
214 open position end

1. A louvre window having:
a frame, the frame having a head, a sill and at least two jambs;
a handle mounted to the frame;
a plurality of blade assemblies located within the frame, each blade assembly having:
a center blade connected to the handle, such that the center blade pivots about a blade assembly axis when the handle is actuated;
a first blade connected to the center blade;
a first windowpane attached to the first blade;
a second blade connected to the center blade; and
a second windowpane attached to second blade,
wherein operation of the handle causes movement of the center blade between an open position and a closed position, wherein in the closed position the first windowpane is separated from the second windowpane by a first distance, and in the open position the first windowpane is separated from the second windowpane by a second distance,
wherein the first distance is less than the second distance.

2. The louvre window of claim 1, wherein the first and second blades are connected to the center blade by a blade linkage.

3. The louvre window of claim 2, wherein the blade linkage is pivotally mounted to the first blade, the second blade, and the center blade so as to be pivotable about first, second, and center linkage axes, respectively.

4. The louvre window of claim 3, wherein the first, second, and center linkage axes are parallel to the blade assembly axis.

5. The louvre assembly of claim 2, wherein the blade linkage includes at least two rigid blade linkage members, such that the first blade and the second blade remain parallel when the blade assembly moves between the open and closed positions.

6. The louvre assembly of claim 3, wherein the first and/or second blade include cut-outs within which the blade linkage is mounted to each blade.

7. The louvre window of claim 1, wherein the frame includes a blade guide groove, and the first blade includes a cam that is locatable in the blade guide groove,
wherein the blade guide groove is shaped such that when the blade assembly is moved between the closed position and the open position, the cam urges the first blade to move relative to the center blade.

8. The louvre window of claim 6, wherein the groove includes a first portion adjacent a closed position end that extends substantially radially to the blade assembly axis, such that the change in separation between the first windowpane and the second windowpane between the first distance and the second distance occurs before substantial rotation of the blade assembly, and a second portion that extends substantially azimuthally to the blade assembly axis, such that the second distance is maintained during substantial rotation of the blade assembly.

9. The louvre window of claim 1, wherein the first and/or second blade include a recess for accommodating at least a portion of the center blade, such that a width of the blade assembly in the closed position is less than the sum of a center blade width, a first blade width, and a second blade width.

10. The louvre window of claim 1, wherein, when the blade assembly is in the closed position, the first windowpane and the second windowpane are substantially vertically aligned.

11. The louvre window of claim 10, wherein the plurality of blade assemblies includes a lower blade assembly and an upper blade assembly, and, when the blade assemblies are in the closed position, an upper end of the first windowpane of the first blade assembly and a top-most portion of the second windowpane of the first blade assembly meet a bottom-most portion of the first windowpane of the second blade assembly and a bottom-most portion of the second windowpane of the second blade assembly, respectively, each meeting creating a seal line,
wherein the seal lines of the first and second windowpanes are substantially vertically aligned.
